(19) United States
(12) Patent Application Publication
(10) Pub. No.: US 2007/0085411 A1
(43) Pub. Date: Apr. 19, 2007

(54) Wheel rim arrangement

(76) Inventor: Mexa Chiu, Taipei (TW)

Correspondence Address: LOWE HAUPTMAN BERNER, LLP, 1700 DIAGONAL ROAD, SUITE 300, ALEXANDRIA, VA, 22314, US

(21) Appl. No.: 11/316,880

(22) Filed: Dec. 27, 2005

(30) Foreign Application Priority Data
Oct. 18, 2005 (TW) 094218013

(51) Int. Cl. B60B 7/04

(52) U.S. Cl. 301/37.25

(57) ABSTRACT

A wheel rim arrangement is disclosed to include a rim mounted on a wheel of a motor vehicle, a connecting member affixed to the rim, a bearing mounted on a hub at the center of the connecting member, a rim cap with a commercial design on the outside wall, and a counterweight mounted on the bearing to hold the rim cap on the rim and to keep the rim cap immovable upon rotation of the rim with the wheel.

### BACKGROUND OF THE INVENTION

1. Field of the Invention

The present invention relates to wheel rims and more particularly, to a wheel rim arrangement, which has a commercial design for commercial purpose that can clearly be seen when the wheel rim is rotated with the wheel during running of the motor vehicle.

2. Description of the Related Art

A motor vehicle wheel generally comprises a wheel rim, a tire mounted on the wheel rim, and a rim cap covered on the wheel rim. The rim cap is affixed to the wheel rim for protection. During running of the motor vehicle, the rim cap is rotated with the wheel rim. This design of rim cap can only be used to shield the wheel rim. In case the rim cap is provided with a commercial design, the commercial design cannot be clearly seen when the rim cap is rotated with the wheel rim during running of the motor vehicle on the road.

### SUMMARY OF THE INVENTION

The present invention has been accomplished under the circumstances in view. It is one object of the present invention to provide a wheel rim arrangement, which has a commercial design for commercial purpose that can clearly be seen when the wheel rim is rotated with the wheel during running of the motor vehicle.

To achieve this and other objects of the present invention, the wheel rim arrangement comprises a rim for mounting on a wheel of a motor vehicle, a connecting member affixed to the rim, a bearing mounted on a hub at the center of the connecting member, a counterweight mounted on the bearing, and a rim cap affixed to the counterweight. The rim cap has the outer surface provided with a commercial design. By means of the effect of the counterweight, the rim cap is kept immovable when the rim is rotated with the wheel of the motor vehicle, and therefore the commercial design at the rim cap is clearly seen during running of the motor vehicle.

### BRIEF DESCRIPTION OF THE DRAWINGS

FIG. 1 is an exploded view of the preferred embodiment of the present invention.

FIG. 2 is a sectional view of the preferred embodiment of the present invention.

FIG. 3 is a schematic plain view of explaining the design of the elongated radial mounting slots of the connecting member according to the present invention.

### DETAILED DESCRIPTION OF THE INVENTION

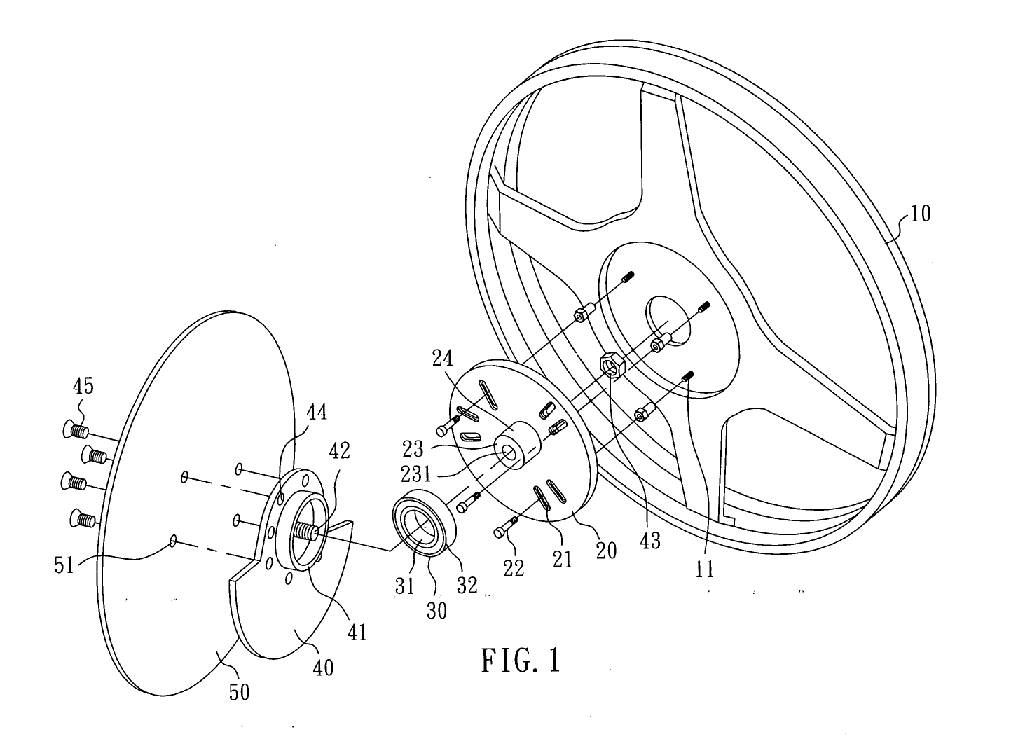

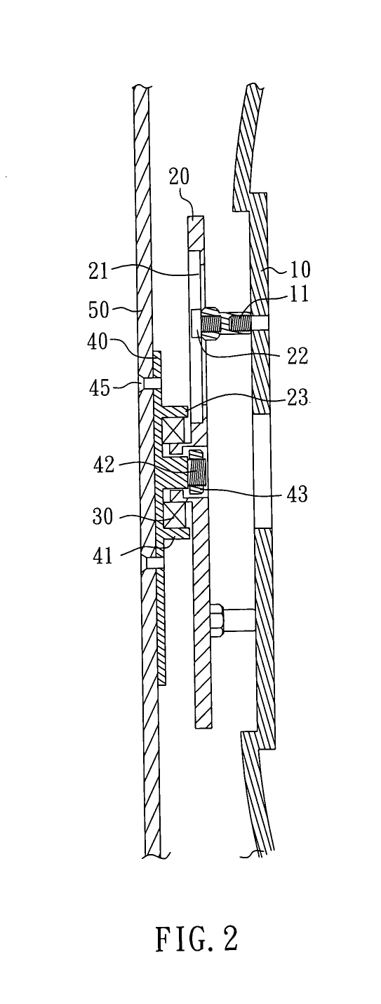

Referring to FIGS. 1 and 2, the preferred embodiment of a wheel rim arrangement in accordance with the present invention is shown comprising a rim 10, a connecting member 20, a bearing 30, a counterweight 40, and a rim cap 50.

The rim 10 has a plurality of mounting rods 11 perpendicularly extending from one side thereof and equiangularly spaced around the center.

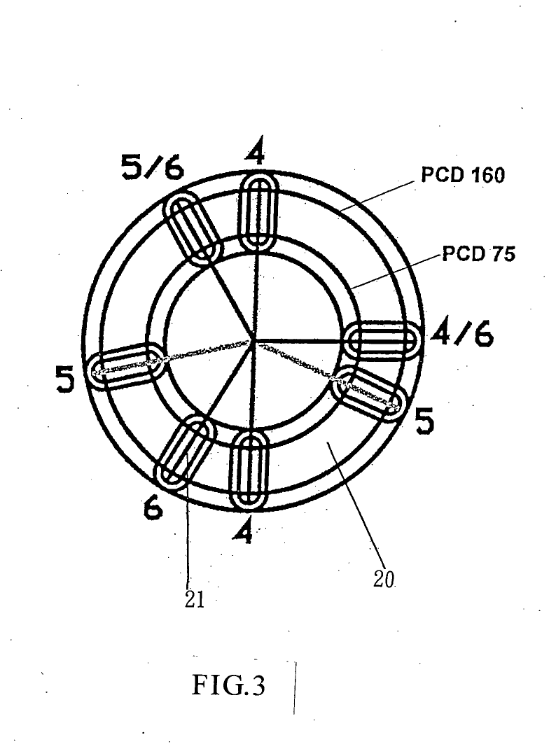

The connecting member 20 is a disk-like plate member having a center through hole 231, a hub 23 perpendicularly protruded from the center of one side thereof around the center through hole 231 and a plurality of, for example, seven elongated radial mounting slots 21 cut through the two opposite sides thereof and spaced around the hub 23. Fastening screw members 22 are inserted through the elongated radial mounting slots 21 and fastened to the mounting rods 11 to affix the connecting member 20 to the rim 10. The seven elongated radial mounting slots 21 are made on the connecting member 20 to fit the PCD and nuts or bolt holes) of any of a variety of commercially available wheel rims (see FIG. 3). A commercially available wheel rim may have 4 bolt holes that are equiangularly spaced from one another at 90-degrees, 5 bolt holes that are equiangularly spaced from one another at 72-degrees, or 6 bolt holes that are equiangularly spaced from one another at 60-degrees. The design of the seven elongated radial mounting slots 21 fits the bolt holes of any of a variety of commercially available wheel rims, i.e., the connecting member 20 is compatible to any of a variety of commercially available wheel rims.

The bearing 30 is supported on the hub 23 of the connecting member 20, having an inner diameter 31 fitting the outer diameter 24 of the hub 23.

The counterweight 40 is semicircular metal block supported on the outer diameter 32 of the bearing 30 at the hub 23 of the connecting member 20, having an annular coupling flange 41 coupled to the outer diameter 24 of the hub 23, a mounting screw rod 42 perpendicularly extending from one side thereof at the center of the annular coupling flange 41, and a plurality of mounting through holes 44 cut through the two opposite sides and equiangularly spaced around the annular coupling flange 41. The mounting screw rod 42 of the counterweight 40 is inserted through the center through hole 231 of the connecting member 20, and then a nut 43 is threaded onto the mounting screw rod 42 to secure the counterweight 40 to the bearing 30 and the connecting member 20, allowing rotation of the counterweight 40 relative to the connecting member 20 and the rim 10.

The rim cap 50 has a plurality of mounting through holes 51 respectively fastened to the mounting through holes 44 of the counterweight 40 with screws 45. Further, the rim cap 50 has the outer surface printed or marked with a logo or commercial design for advertisement purpose.

Referring to FIGS. 1 and 2 again, during rotation of the rim 10 with the wheel of the motor vehicle (not shown), the connecting member 20 is rotated with the rim 10, however the rim cap 50 is kept immovable. Because the rim cap 50 is affixed to the counterweight 40, which is rotatably supported on the bearing 30 at the hub 23 of the connecting member 20, the rim cap 50 is kept immovable when rotating the rim 10. Therefore, the logo or commercial design at the rim cap 50 is clearly seen when the motor vehicle is running on the road.

A prototype of wheel rim arrangement has been constructed with the features of FIGS. 1˜3. The wheel rim arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A wheel rim arrangement comprising:
a rim for mounting on a wheel of a motor vehicle;
a connecting member affixed to said rim, said connecting member having a hub;
a bearing mounted on said hub of said connecting member;
a counterweight mounted on said bearing; and
a rim cap affixed to said counterweight, said rim cap having an outer surface provided with a commercial design;
wherein said counterweight holds said rim cap immovable upon rotation of said rim.

2. The wheel rim arrangement as claimed in claim 1, wherein said connecting member has a plurality of elongated mounting slots spaced around the center thereof for mounting.

3. The wheel rim arrangement as claimed in claim 1, wherein said connecting member has a center through hole defined in said hub; said counterweight has an annular coupling flange coupled to said bearing, and a mounting screw rod perpendicularly extending from one side thereof at the center of said annular coupling flange and inserted through the center through hole of said connecting member and screwed up with a nut that secures said mounting screw rod of said counterweight to said connecting member for allowing rotation of said counterweight and said rim cap relative to said connecting member and said rim.
